(19) United States
(12) Patent Application Publication
(10) Pub. No.: US 2010/0114708 A1
(43) Pub. Date: May 6, 2010

(54) METHOD AND APPARATUS FOR PROVIDING ROAD-TRAFFIC INFORMATION USING ROAD-TO-VEHICLE COMMUNICATION

(76) Inventors: Yoshikazu OOBA, Hachioji-shi (JP); Yasuhiro Shibata, Yokohama-shi (JP); Hideki Ueno, Urayasu-shi (JP); Kazuyoshi Fujii, Fuchu-shi (JP); Toshiro Adachi, Saitama-shi (JP); Kazunori Iwasaki, Fuchu-shi (JP); Masaharu Doi, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/607,813

(22) Filed: Oct. 28, 2009

(30) Foreign Application Priority Data
Oct. 31, 2008 (JP) 2008-282354

(51) Int. Cl. G08G 1/00; G06Q 30/00; G06F 15/16

(52) U.S. Cl. 705/14.62; 701/117; 709/217

(57) ABSTRACT

According to one embodiment, a system is provided, which provides moving picture data representing a road-traffic state. This system synthesizes the moving picture data with additional data such as advertisement data, generating output data. The system distributes the output data to the facilities built along the road and the vehicles running on the road.

### CROSS-REFERENCE TO RELATED APPLICATIONS

This application is based upon and claims the benefit of priority from prior Japanese Patent Application No. 2008-282354, filed Oct. 31, 2008, the entire contents of which are incorporated herein by reference.

### BACKGROUND OF THE INVENTION

1. Field of the Invention

The present invention relates to a technique of providing the road-traffic information showing the present traffic states on roads, by using, in particular, the moving picture data acquired by cameras.

2. Description of the Related Art

In the recent years, a system that provides information about the road-traffic states to vehicles running on roads has been developed. The information provided to the vehicles consists of numerical data and graphic data that show the travel time each vehicle required needs to travel to a specific destination and the current congestion states on various roads. The numerical data and graphic data are of the type that is displayed on the variable data displays provided along roads.

One of the road-traffic information providing systems hitherto known is the car navigation system that corresponds to a road-traffic information providing system called “vehicle information and communication system (VICS). The car navigation system is now very popular as a car-mounted system. The information provided by VICS, i.e., information about the road-traffic states, can be displayed as character data or graphic data, on a display screen. VICS is a system that provides macro information about any district that has roads.

A system for providing moving-image data has been proposed in connection with a system that controls the video data generated by monitor cameras. This system takes some measures against illegal acquisition of such video data. (See, for example, Jpn. Pat. Appln. KOKAI Publication No. 2005-277636.) Further, a moving picture providing system has been proposed, which can display advertisement data on the map being displayed. (See, for example, Jpn. Pat. Appln. KOKAI Publication No. 2003-202235.)

The system that gives information about the road-traffic states, using the moving pictures photographed by cameras, is useful because the driver of any vehicle can know, in real time, the present traffic-sates on various roads. The moving pictures include pictures photographed by roadside CCTV cameras.

If advertisement on merchandise items and service items is merged with the moving pictures, the information will be valuable not only to the driver, but also to any occupant of the vehicle, who may use the service areas along turnpikes. The advertisement may pertain to the merchandise items and service items the road facility for service business. In this case, the road facility for service business may sponsor the road-traffic information, adding some value to the road-traffic information.

### BRIEF SUMMARY OF THE INVENTION

An object of this invention is to provide a system for providing road-traffic information that can provides valuable and useful road-traffic information, by synthesizing moving picture data about road traffic states with additional data such as advertisement data.

According to an aspect of this invention, there is provided a road-traffic information providing system that synthesizes the moving picture data generated from moving pictures acquired by cameras, with additional data such as advertisement data advertising merchandise items and various service items.

The road-traffic information providing system according to the aspect of this invention comprises a transmission unit configured to transmit moving picture data representing the road-traffic states photographed by cameras; an acquisition unit configured to acquire additional data; a synthesis unit configured to synthesize the moving picture data with the additional data, thereby generating road-traffic information; and an information-providing unit configured to provide the road-traffic information to objects that should receive the information.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram explaining the configuration of a system according to a first embodiment of this invention;

FIG. 2 is a diagram showing an exemplary information item displayed in the system according to an embodiment;

FIGS. 3A to 3C are diagrams explaining how images are synthesized to generate a synthesized image in the system according to an embodiment;

FIG. 4 is a flowchart explaining how the system according to an embodiment operates; and

FIG. 5 is a block diagram explaining the configuration of a system according to a second embodiment of this invention.

### DETAILED DESCRIPTION OF THE INVENTION

Embodiments of this invention will be described with reference to the accompanying drawings.

### First Embodiment

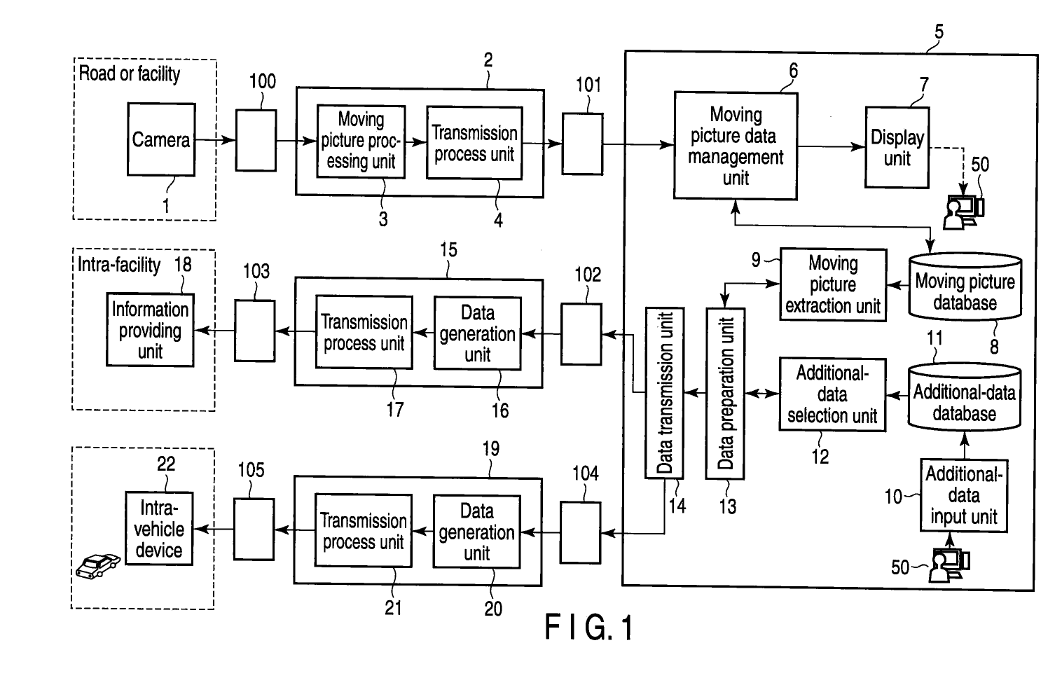

FIG. 1 is a block diagram showing the major components of a road-traffic information providing system according to a first embodiment of this invention.

As shown in FIG. 1, the system according to this embodiment comprises a camera 1, a roadside information-collecting unit 2, a center system 5, an intra-facility unit 15, an intra-facility information providing unit 18, a roadside information-providing unit 19, and an intra-vehicle device 22. The center system 5 and the units 2, 15 and 19 each include a computer composed of software and hardware. The intra-vehicle device 22 is provided in a vehicle.

The camera 1 is a monitor camera that is a movie-camera or a closed circuit television (CCTV) camera, etc. It is installed at a photographing point set on a roadside or set in a service area or parking area built on a turnpike. The camera 1 outputs a video signal that represents a moving picture showing the road-traffic state at the photographing point.

The road-traffic state is mainly the traffic of vehicles running on the road. The road includes a road in any facility that is a road facility for service business. The roadside information-collecting unit 2 is an apparatus installed on a side of the road. The roadside information-collecting unit 2 is connected to the camera 1 by a wired communication path 100. The unit 2 acquires the moving picture from the camera 1. The unit 2 includes a moving picture processing unit 3 and a transmission process unit 4. The moving picture processing unit 3 processes any video signal output from the camera 1.

The moving picture processing unit 3 compresses moving picture data, using moving picture compressing scheme such as Moving Picture Experts Group 4 (MPEG-4), in order to increase the transmission efficiency. The transmission process unit 4 transmits receives the moving picture data from the moving picture processing unit 3 and transmits the same, as a National Television System Committee (NTSC) signal, to the center system 5 through a wired communication path 101.

The center system 5 includes a moving picture data management unit 6, a controller's display unit 7, a moving picture database 8, a moving picture extraction unit 9, an additional-data input unit 10, a additional-data database 11, an additional-data selection unit 12, an output-data preparation unit 13, and an output-data transmission unit 14.

A controller's terminal 50 is provided in the center system 5 and is connected to the center system 5. The controller's terminal 50 has a display screen for displaying the moving picture data supplied from the controller's display unit 7. The controller's terminal 50 is connected to the addition-data input unit 10, too, and can therefore accumulate additional data, such as advertisement, in the additional-data database 11.

The intra-facility unit 15 is installed in a road facility for service business such as a service area or a parking area that is built on a turnpike. The intra-facility unit 15 is connected by a wired communication path 102 to the center system 5 and can therefore receive the output data transmitted from the output-data transmission unit 14. The “output data” is data generated by synthesizing moving picture data representing the road traffic state and additional data representing advertisement, etc. The intra-facility unit 15 includes an intra-facility data generation unit 16 and an intra-facility transmission unit 17. The intra-facility data generation unit 16 generates data for use in the facility, from the output data received from the center system 5. The intra-facility transmission unit 17 transmits the data generated by the unit 16, to the intra-facility information providing unit 18 through a wired communication path 103.

The intra-facility information providing unit 18 displays the output data (i.e., data generated by the intra-facility data generation unit 16) that has been transmitted from the intra-facility transmission unit 17 provided in the intra-facility unit 15. More specifically, the intra-facility information providing unit 18 has a display installed in the a road facility for service business such as service area or parking area built on the turnpike. Thus, the output data is displayed on the screen of this display.

The roadside information-providing unit 19 is installed at the roadside (including the road build in the facility). The unit 19 is connected by a wired communication path 104 to the center system 5, and can receive the output data transmitted from the output-data transmission unit 14. The roadside information-providing unit 19 includes an output-data generation unit 20 and a roadside transmission unit 21.

The output-data generation unit 20 generates output data for use in the vehicle, from the output data received from the center system 5. The roadside transmission unit 21 transmits the output data, thus generated, to the intra-vehicle device 22 through a wireless communication path 105. The wireless communication path 105 is a wireless communication facility of dedicated short-range communication (DSRC) type. Note that the wired communication paths 100 to 104 are transmission paths that constitute, for example, a wired network.

The intra-vehicle device 22 is provided in the vehicle and includes a monitor and a wireless communication device DSRC system. The intra-vehicle device 22 has a monitor, which displays on its screen the output data transmitted through the wireless communication path 105. The intra-vehicle device 22 may be replaced by a device integrated, in terms of function, with the conventional car navigation system.

### (Operation of the System)

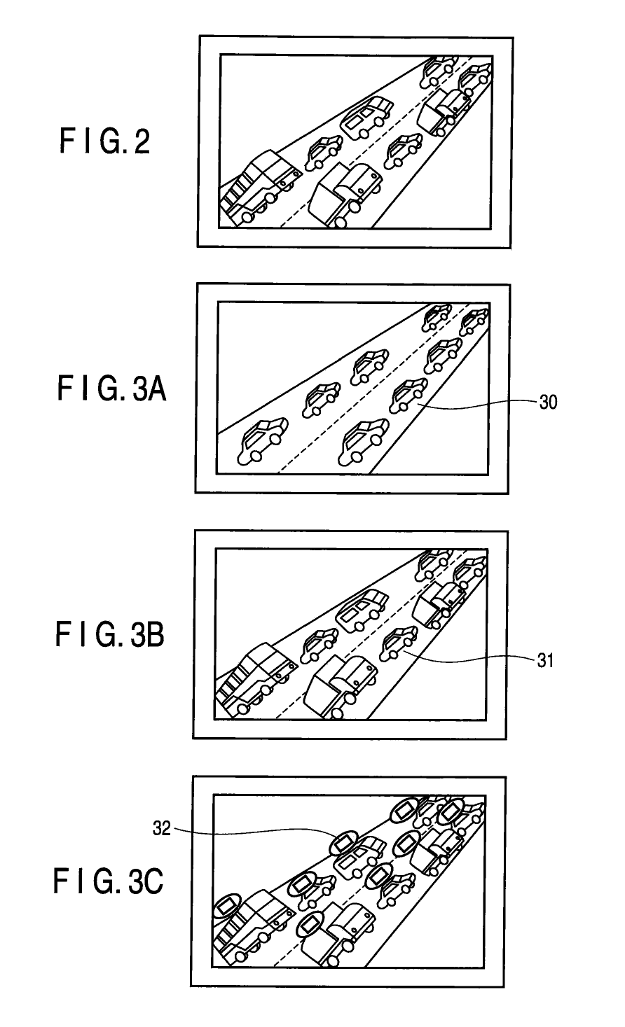

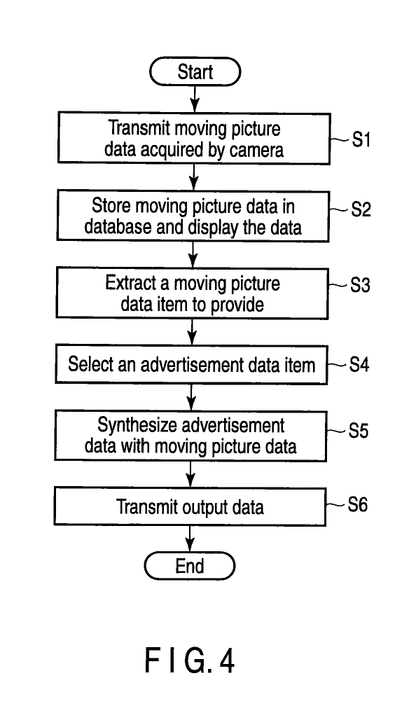

How the system according to this embodiment operates will be explained with reference to FIGS. 2, 3A to 3C, and 4.

First, the roadside information-collecting unit 2 collects the moving picture data the camera 1 has acquired. The moving picture data is transmitted from the unit 2 to the center system 5 through the wired communication path 101 (Step S1). The camera 1 is photographing the road traffic near the service area or parking area or at a position preset as a photographing point.

In the center system 5, the moving picture data management unit 6 receives the moving picture data and stores the same in the moving picture database 8 and, at the same time, outputs the moving picture data to the controller's display unit 7 (Step S2). The controller's display unit 7 expands the moving picture data that has been compressed. The moving picture data thus expanded is output to the controller's terminal 50. The controller's terminal 50 displays the moving picture data on its monitor screen, as is illustrated in FIG. 2. The controller views the moving picture data thus displayed on the monitor screen, grasping the road-traffic state at the position where the camera 1 is installed.

Next, the moving picture extraction unit 9 extracts moving picture data to give the driver and occupants of the vehicle or the users of the road facility for service business (i.e., service area or parking area), from the moving picture data accumulated in the moving picture database 8 (Step S3). The moving picture data extracted by the moving picture extraction unit 9 represents chronically congested locations, traffic-branch units, traffic-confluence units, traffic inflows and outflows at toll gates, or the traffic states at the entrance to and exit from the service area or parking area. Further, the moving picture extraction unit 9 may extract moving picture data that represents the traffic state at any parking area in the road facility for service business. The moving picture extraction unit 9 extracts moving picture data in accordance with the position data input from the controller's terminal 50 and representing the location of the camera 1. The moving picture data, thus extracted, is output to the output-data preparation unit 13. Here, it is assumed that the moving picture data represents the traffic states at the entrance to and exit from the service area or parking area.

The additional-data selection unit 12 selects, for example, the advertisement data about merchandise items and service from the additional data accumulated in the additional-data database 11 and outputs the same to the output-data preparation unit 13 (Step S4). The additional-data database 11 accumulates advertisement data that has been input from the controller's terminal 50 through the addition-data input unit 10. The advertisement data includes video data, text data, marks, campaign colors, etc., about the merchandise items. Examples of the advertisement data are the video data representing the image of a vehicle advertised, the text data representing the name of the vehicle, or the mark such as the trademark of the car manufacturer.

The additional-data selection unit 12 can select an advertisement data item from the additional-data database 11 in accordance with data representing selection conditions such as the destination of moving picture data, the time of providing the moving picture data and the road-traffic state. The data representing these selection conditions is input at the controller's terminal 50. More precisely, the data representing the selection conditions represents the place where the merchandise item should be advertised and the time when the merchandise item should be advertised. The place where the merchandize item should be advertised is, for example, a specific service area, a particular parking area, or the exit from a particular toll gate. The time when the merchandise item should be advertised is, for example, morning, daytime or night on weekdays, holidays or national holidays. The data representing the selection conditions represents, for example, a desirable average vehicle speed n (km/h) calculated from road-traffic states such as the average speed of the vehicles, the volume of traffic and the number of vehicles per unit area, from which to determine whether traffic congestion exists or not.

The output-data preparation unit 13 synthesizes the moving picture data extracted by the moving picture extraction unit 9 with the advertisement data selected by the additional-data selection unit 12, thereby generating moving picture data (i.e., output data) (Step S5). More precisely, the output-data preparation unit 13 performs a motion vector process on the input moving picture data, recognizing the vehicles represented by the data, as objects, by utilizing, for example, the conventional encoding (i.e., compression) technique. Moreover, the output-data preparation unit 13 utilizes the data representing the vehicles thus recognized as objects, synthesizing the moving picture data and the advertisement data. Note that the output-data preparation unit 13 may perform a vector-image process in order to extract the images of vehicles from the moving picture data and to track the images thus extracted.

The output-data preparation unit 13 synthesizes the moving picture data with the additional data, by performing an overlapping process of overlapping the advertisement data on a vehicle object, the advertisement data being, for example, video data representing the image of a vehicle advertised, text data representing the name of the vehicle, or a mark such as the trademark of the car manufacturer. Further, the output-data preparation unit 13 can paint all vehicles represented by the moving picture data in a specific campaign color, by using color data representing the campaign color.

The output-data transmission unit 14 transmits the output data generated by the output-data preparation unit 13 via the wired communication paths 102 and 104 to the intra-facility unit 15 and roadside information-providing unit 19, by means of TCP/IP communication or streaming transmission (Step S6). Before transmitting the output data, the output-data transmission unit 14 compresses the output data if the moving picture data contained in the output data has been expanded by the output-data preparation unit 13.

In the intra-facility unit 15, the intra-facility data generation unit 16 receives the output data and converts the same time to data that will be used in the road facility for service business. The data thus converted is ordinary compressed moving picture data if such data is desirable. If still picture data is desired, the unit 16 will converts the output data to still picture data that represents consecutive still pictures. The intra-facility transmission unit 17 transmits the data generated by the unit 16 to the intra-facility information providing unit 18 by means of TCP/IP communication or streaming transmission.

The intra-facility information providing unit 18 may be located outdoors and the can hardly be connected to the intra-facility transmission unit 17 by the wired communication path 103. In this case, the unit 18 can be connected to the unit 17 by utilizing wireless communication path such as a wireless LAN. The intra-facility information providing unit 18 has a display such as a monitor or a liquid crystal TV (i.e., liquid crystal display). The display displays the output data supplied from the intra-facility unit 15.

To be more specific, the intra-facility information providing unit 18 performs a conversion process, either displaying on its screen a moving picture showing various types of vehicles (FIG. 2) and an advertised vehicle 30, or displaying images of the advertised vehicle 30 in place of various types of vehicles, as is illustrated in FIG. 3A. Alternatively, as shown in FIG. 3B, the intra-facility information providing unit 18 may display a moving picture showing various types of vehicles and text data items 31, each being an advertisement data item added to the image of one vehicle. Still alternatively, as shown in FIG. 3C, the intra-facility information providing unit 18 may display a moving picture showing various types of vehicles and images 32 of a merchandize item advertised, each added to the image of one vehicle. Each text data item 31 is, for example, the name of a merchandize item advertised. Each of the images 32 is, for example, a loaf of bread advertised.

Similarly, in the roadside information-providing unit 19, the output-data generation unit 20 receives the output data transmitted from the output-data transmission unit 14 and converts the same to data that will be used in the intra-vehicle device 22. The data thus converted is ordinary compressed moving picture data if such data is desirable. If still picture data is desired, the roadside information-providing unit 19 will converts the output data to still picture data that represents consecutive still pictures. The roadside transmission unit 21 transmits the output data generated by the output-data generation unit 20 to the intra-vehicle device 22 through the wireless communication path 105 that achieves, for example beacon communication utilized in DSRC or VICS communication. The intra-vehicle device 22 displays, on its monitor screen, such moving picture data having such advertisement data as shown in FIG. 3A, 3B or 3C.

In the system according to this embodiment, which is configured as described above, a moving picture having such advertisement data as shown in FIG. 3A, 3B or 3C can be displayed by the display screen of a display provided in the road facility for service business such as a service area or parking area built on any turnpike and by the monitor screen of the intra-vehicle device 22 provided in a vehicle. Hence, any person using the road facility for service business such as a service area or parking area and the driver of the vehicle can not only confirm the road-traffic state at the photographing point preset, but also see the advertisement about merchandise or service. This increases the probability that the facility user and the car driver buys the advertised merchandise item, e.g., bread sold at the shop operating in a service area. Not only the facility user and the car driver, but also the people working in the road facility for service business can see the advertisement and know the road-traffic state.

From the advertisement data that should be added to the moving picture data representing the road-traffic state, an advertisement data item may be selected in accordance with the time or plate at which to advertise the merchandise item or service item. If this is the case, the advertisement will be more effective than otherwise. In the morning, for example, it is advisable to display advertisement of merchandize items necessary at this time of the day (e.g., foods for breakfast). At such a time or in such a place, where traffic congestion may occur, the monitor screen of the intra-vehicle device 22 may display an advertisement data item about music DCs. This increases the probability that the car driver buys a music CD at a shop in a service area. The advertisement data item displayed is therefore effective.

The charge for providing advertisement data may be set in accordance with the road-traffic state at the place where the data should be displayed. Thus, an appropriate advertisement sponsor and a suitable merchandise item can be selected in accordance with the road-traffic state at any position the vehicle is travelling.

Moreover, the system according to this embodiment can display both a road-traffic state and advertisement at the same time. Therefore, the system gives useful information not only to the car driver and the facility user, but also to the road management firm, the facility company and the advertisement agent. The information helps the firm, company and agent to achieve good coordination.

As has been described, the system of this embodiment synthesizes moving picture data representing a road-traffic state with additional data such as advertisement, thereby providing effective and useful road-traffic information.

### Second Embodiment

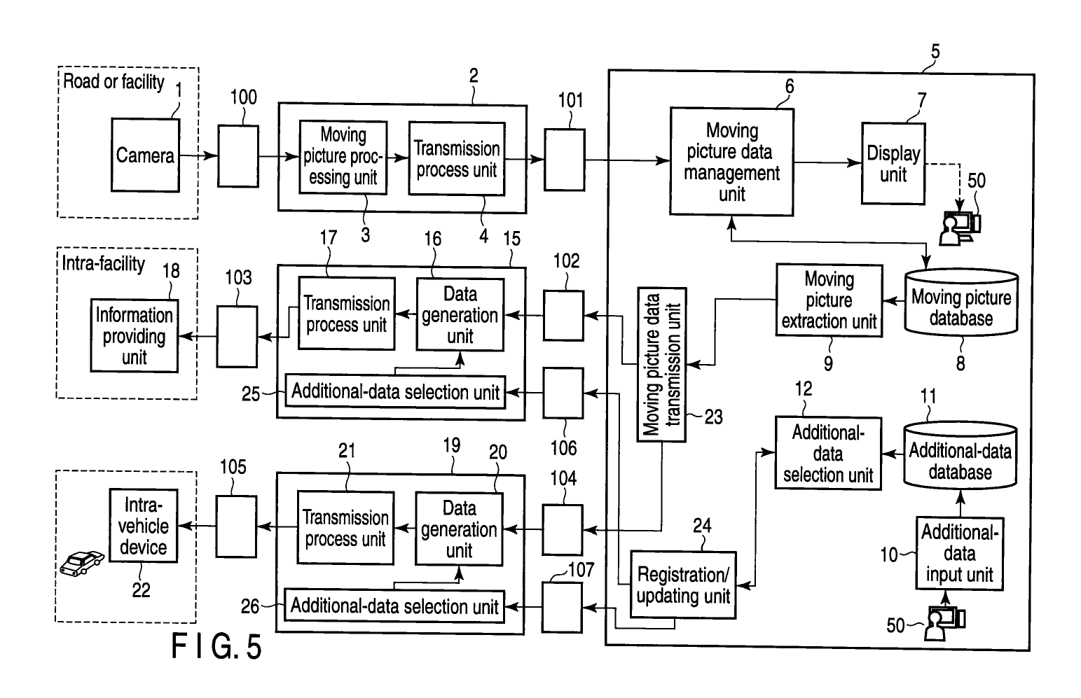

FIG. 5 is a block diagram showing the major components of a system according to a second embodiment of this invention.

As shown in FIG. 5, the system according to this embodiment comprises a center system 5, an intra-facility unit 15, and a roadside information-providing unit 19. The center system 5 includes a moving picture data transmission unit 23 and an additional-data registration/updating unit 24. The intra-facility unit 15 includes an intra-facility additional-data selection unit 25. The roadside information-providing unit 19 includes a roadside additional-data selection unit 26. The system of FIG. 5 has other components, which are identical to those of the first embodiment shown in FIG. 1. The other components are therefore designated by the same reference numbers and will not be described in detail.

The operation of the system according to this embodiment will be explained below. Nonetheless, how the components identical to those of the first embodiment operate will not be described.

In the system according to this embodiment, the moving picture data transmission unit 23 transmits moving picture data through the wired communication paths 102 and 104 to the intra-facility unit 15 and roadside information-providing unit 19, respectively. Note that the moving picture data thus transmitted has been extracted by the moving picture extraction unit 9 from the moving picture data accumulated in the moving picture database 8.

On the other hand, the additional-data registration/updating unit 24 provides additional data through the wired communication paths 106 and 107 to the intra-facility unit 15 and roadside information-providing unit 19, respectively. Note that the additional data thus provided has been extracted by the additional-data selection unit 12 from the additional data accumulated in the additional-data database 11.

In the intra-facility unit 15, the intra-facility additional-data selection unit 25 registers the advertisement data received from the additional-data registration/updating unit 24, selects an advertisement data item to be synthesized with the moving picture data, in accordance with the place and time at which to display the advertisement data item, and outputs the advertisement data item to the intra-facility data generation unit 16. The intra-facility data generation unit 16 synthesizes the advertisement data item selected by the intra-facility additional-data selection unit 25 with the moving picture data received from the moving picture data transmission unit 23, thereby generating output data. Note that the intra-facility data generation unit 16 performs the data synthesis in the same way as does the output-data preparation unit 13 shown in FIG. 1.

The intra-facility transmission unit 17 transmits the data generated by the intra-facility data generation unit 16 through the wired communication path 103 to the intra-facility information providing unit 18 that is provided in the facility. The intra-facility information providing unit 18 displays, on its display screen, the output data transmitted from the intra-facility transmission unit 17.

In the roadside information-providing unit 19, the roadside additional-data selection unit 26 registers the advertisement data received from the additional-data registration/updating unit 24, selects an advertisement data item to be synthesized with the moving picture data, in accordance with the place and time at which to display the advertisement data item, and outputs the advertisement data item to the output-data generation unit 20.

The output-data generation unit 20 synthesizes the advertisement data item selected by the roadside additional-data selection unit 26 with the moving picture data received from the moving picture data transmission unit 23, thereby generating output data. Note that the output-data generation unit 20 performs the data synthesis in the same way as does the output-data preparation unit 13 shown in FIG. 1.

The roadside transmission unit 21 transmits the output data generated by the output-data generation unit 20 to the intra-vehicle device 22 through the wireless communication path 105. The intra-vehicle device 22 displays, on its monitor screen, the output data transmitted through the wireless communication path 105.

The system according to the second embodiment can achieve the same advantages as the system according to the first embodiment. That is, this system can provide the car driver and any facility user with the moving picture data and the advertisement data at the same time (see FIGS. 3A to 3C). The car driver and facility user can therefore easily grasp the road-traffic state and see the advertisement about merchandise and service. Hence, not only the facility user and car driver, but also the people working in the facility can see the advertisement and know the road-traffic state. Thus, the system gives effective and useful road-traffic information.

Moreover, the system according to either embodiment, the advertisement data is synthesized with the moving picture data representing the road-traffic state, not in the center system 5, but in the intra-facility unit 15 and roadside information-providing unit 19. This can reduce the work load of the center system 5 in connection with the synthesis of moving picture data and advertisement data.

In either embodiment described above, the moving picture data or the output data obtained by synthesizing the moving picture data and advertisement data is transmitted to the intra-facility information providing unit 18 and intra-vehicle device 22. This invention is not limited to the embodiments, nevertheless. The invention can be applied to information providing service in which the output data is transmitted to mobile terminals.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for providing road-traffic information, comprising:
a transmission unit configured to transmit moving picture data representing a road-traffic state photographed by a camera;
a data acquisition unit configured to acquire additional data;
a synthesis unit configured to synthesize the additional data with the moving picture data, thereby generating output data; and
a data providing unit configured to transmit the output data to a device that should receive the data.

2. The apparatus according to claim 1, further comprising:
a data storage unit configured to accumulate the moving picture data transmitted by the transmission unit; and
an extraction unit configured to extract moving picture data to provide, from the data storage unit,
wherein the synthesis unit synthesizes the additional data with the moving picture data extracted by the extraction unit, thereby generating the output data.

3. The apparatus according to claim 1, wherein the camera is installed on a road or in a facility built on the road, and the transmission unit includes an image processing unit configured to process the moving picture data output from the camera.

4. The apparatus according to claim 1, wherein the data providing unit transmits the output data to an intra-facility information providing unit provided in a facility built on a road or to an intra-vehicle device provided in a vehicle running on the road, by utilizing wired communication or wireless communication.

5. The apparatus according to claim 4, wherein the data providing unit is installed in a service area or parking area, which is a facility built in the premises of a turnpike.

6. The apparatus according to claim 1, wherein the data acquisition unit acquires, as the additional data, advertisement data linked to shops built on a road or in a facility built on the road.

7. The apparatus according to claim 2, wherein the data acquisition unit acquires, as the additional data, advertisement data linked to shops built on a road or in a facility built on the road.

8. The apparatus according to claim 2, further comprising:
a center system including the data storage unit, the extraction unit and the data acquisition unit; and
an information providing device provided in a facility built on a road, connected to the center system by means of wired communication or wireless communication, and including the data acquisition unit and the data providing unit.

9. The apparatus according to claim 2, further comprising:
a center system including the data storage unit, the extraction unit and the data acquisition unit; and
an information providing device provided in a facility built on a road, connected to the center system by means of wired communication or wireless communication, including the synthesis unit and the data providing unit and configured to transmit the output data from the data providing unit to an intra-vehicle device provided in a vehicle running on the road, by utilizing wired communication or wireless communication.

10. The apparatus according to claim 1, wherein the synthesis unit includes a unit configured to superimpose the image of an advertised vehicle, which is represented by the additional data, on the images of vehicles represented by the moving picture data.

11. The apparatus according to claim 1, wherein the synthesis unit includes a unit configured to add text data representing the name of an advertised object, to those parts of the moving picture data which represent the images of vehicles.

12. The apparatus according to claim 1, wherein the synthesis unit includes an unit configured to add graphic data representing an advertised object represented by the additional data, to those parts of the of the moving picture data which represent the images of vehicles.

13. The apparatus according to claim 1, wherein the synthesis unit includes a unit configured to add color data representing a specific color, to those parts of the of the moving picture data which represent the images of vehicles.

14. The apparatus according to claim 1, wherein the data providing unit includes a unit configured to change the output data in accordance with the traffic state on the road, the time at which to transmit the output data and the place to which to transmit the output data.

15. A method of providing road traffic information, comprising:
transmitting moving picture data representing a road-traffic state photographed by a camera;
acquiring additional data;
synthesizing the additional data with the moving picture data, thereby generating output data; and
transmitting the output data to a device that should receive the data.
